(19) United States
(12) Patent Application Publication
(10) Pub. No.: US 2014/0313973 A1
(43) Pub. Date: Oct. 23, 2014

(54) DATA OFFLOADING APPARATUS AND METHOD

(71) Applicant: Electronics and Telecommunications Research Institute, Daejeon (KR)

(72) Inventors: No Ik PARK, Daejeon (KR); Young Boo KIM, Sejong (KR)

(73) Assignee: Electronics and Telecommunications Research Institute, Daejeon (KR)

(21) Appl. No.: 14/253,612

(22) Filed: Apr. 15, 2014

(30) Foreign Application Priority Data
Apr. 18, 2013 (KR) 10-2013-0042955

(51) Int. Cl. H04W 40/02; H04L 12/725; H04L 12/707; H04W 40/12

(52) U.S. Cl. CPC H04W 40/02; H04W 40/12; H04L 45/302; H04L 45/22
USPC 370/328

(57) ABSTRACT

Disclosed are a data offloading apparatus and method. The data offloading apparatus according to an embodiment of the present invention includes an analysis unit configured to analyze a type of a packet and a provision unit configured to provide the packet to an Internet network through a mobile core network or through a route of bypassing the mobile core network on the basis of the type of the packet. According to the present invention, a terminal can transmit data to the Internet network through the mobile core network or the route of bypassing the mobile core network according to characteristics of the data.

### CLAIM FOR PRIORITY

This application claims priority to Korean Patent Application No. 10-2013-0042955 filed on Apr. 18, 2013 in the Korean Intellectual Property Office (KIPO), the entire contents of which are hereby incorporated by reference.

### BACKGROUND

1. Technical Field

Example embodiments of the present invention relate in general to a data offloading apparatus and method and more specifically to a data offloading apparatus and method for distributing data concentrated on a mobile core network.

2. Related Art

Highly developed mobile communication technology is rapidly enhancing a data transfer rate. Accordingly, big data, such as a high resolution video, may be transferred through a mobile communication network and thus the amount of data transferred through the mobile communication network has increased explosively.

Furthermore, as the amount of data transferred through the mobile communication network has rapidly increased due to the use of smartphones, data has been further concentrated on a mobile core network for performing functions of, for example, applying a quality of service (QoS) policy, charging, etc.

### SUMMARY

Accordingly, example embodiments of the present invention are provided to substantially obviate one or more problems due to limitations and disadvantages of the related art.

Example embodiments of the present invention provide a data offloading apparatus for offloading data according to the type of the data.

Example embodiments of the present invention also provide a data offloading method for offloading data according to the type of the data.

In some example embodiments, a data offloading apparatus includes an analysis unit configured to analyze a type of a packet and a provision unit configured to provide the packet to an Internet network through a mobile core network or through a route of bypassing the mobile core network according to the type of the packet.

The analysis unit may analyze the type of the packet on the basis of at least one of a header and a payload included in the packet.

The provision unit may provide the packet to the Internet network through the route of bypassing the mobile core network if the type of the packet is an Internet packet and through the mobile core network if the type of the packet is not an Internet packet.

The provision unit may provide the packet to the Internet network through the mobile core network if the type of the packet is a packet necessary to be transmitted according to a QoS policy and through the route of bypassing the mobile core network if the type of the packet is a packet not necessary to be transmitted according to the QoS policy.

The provision unit may provide the packet to the Internet network through the mobile core network if the type of the packet is a packet to be charged for transmission and through the route of bypassing the mobile core network if the type of the packet is a packet not to be charged for transmission.

The mobile core network may be a 4G mobile communication core network.

In other example embodiments, a data offloading apparatus includes a first layer serving as a physical layer; a second layer serving as a data link layer; and an Internet protocol (IP) layer analyzing a type of a packet provided by the second layer to provide the packet to an Internet network through a mobile core network or a route of bypassing the mobile core network according to the analyzed type of the packet.

The IP layer may analyze the type of the packet on the basis of at least one of a header and a payload included in the packet.

The IP layer may provide the packet to the Internet network through the route of bypassing the mobile core network if the type of the packet is an Internet packet and through the mobile core network if the type of the packet is not an Internet packet.

The IP layer may provide the packet to the Internet network through the mobile core network if the type of the packet is a packet necessary to be transmitted according to a QoS policy and through the route of bypassing the mobile core network if the type of the packet is a packet not necessary to be transmitted according to the QoS policy.

The IP layer may provide the packet to the Internet network through the mobile core network if the type of the packet is a packet to be charged for transmission and through the route of bypassing the mobile core network if the type of the packet is a packet not to be charged for transmission.

The mobile core network may be a 4G mobile communication core network.

In still other example embodiments, a data offloading method includes analyzing a type of a packet and providing the packet to an Internet network through a mobile core network or through a route of bypassing the mobile core network according to the type of the packet.

The analyzing of the type of a packet may be performed on the basis of at least one of a header and a payload included in the packet.

The providing of the packet to an Internet network through a mobile core network or a route of bypassing the mobile core network according to the type of the packet may include providing the packet to the Internet network through the route of bypassing the mobile core network if the type of the packet is an Internet packet and through the mobile core network if the type of the packet is not an Internet packet.

The providing of the packet to an Internet network through a mobile core network or a route of bypassing the mobile core network according to the type of the packet may include providing the packet to the Internet network through the mobile core network if the type of the packet is a packet necessary to be transmitted according to a quality of service (QoS) policy and through the route of bypassing the mobile core network if the type of the packet is a packet not necessary to be transmitted according to the QoS policy.

The providing of the packet to an Internet network through a mobile core network or a route of bypassing the mobile core network according to the type of the packet may include providing the packet to the Internet network through the mobile core network if the type of the packet is a packet to be charged for transmission and through the route of bypassing the mobile core network if the type of the packet is a packet not to be charged for transmission.

The mobile core network may be a 4G mobile communication core network.

### BRIEF DESCRIPTION OF DRAWINGS

Example embodiments of the present invention will become more apparent by describing in detail example embodiments of the present invention with reference to the accompanying drawings, in which:

FIG. 1 is a block diagram showing a configuration of a communication network according to an embodiment of the present invention;

FIG. 2 is a block diagram showing a configuration of a data offloading apparatus according to an embodiment of the present invention;

FIG. 3 is a block diagram showing a protocol configuration of a data offloading apparatus according to an embodiment of the present invention;

FIG. 4 is a flowchart illustrating a data offloading method according to an embodiment of the present invention;

FIG. 5 is a flowchart illustrating a data offloading method according to another embodiment of the present invention;

FIG. 6 is a flowchart illustrating a data offloading method according to still another embodiment of the present invention; and

FIG. 7 is a block diagram showing a computer system in which an embodiment of the present invention is implemented.

### DESCRIPTION OF EXAMPLE EMBODIMENTS

While the invention is susceptible to various modifications and alternative forms, specific embodiments thereof are shown by way of example in the drawings and will herein be described in detail.

However, it should be understood that the particular embodiments are not intended to limit the present disclosure to specific forms, but rather the present disclosure is meant to cover all modification, similarities, and alternatives which are included in the spirit and scope of the present disclosure.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Embodiments of the present invention will be described below in more detail with reference to the accompanying drawings. In describing the invention, to facilitate the entire understanding of the invention, like numbers refer to like elements throughout the description of the figures, and a repetitive description on the same element is not provided.

Throughout the specification, a communication network may include a 2G mobile communication network such as Global System for Mobile communication (GSM), Code Division Multiple Access (CDMA), etc., wireless Internet such as Long Term Evolution (LTE) network and Wireless Fidelity (WiFi), portable Internet such as Wireless Broadband Internet (WiBro) and World Interoperability for Microwave Access (WiMax), or a mobile communication network capable of supporting packet transmission (for example, a 3G mobile communication network such as Wideband Code Division Multiple Access (WCDMA) or CDMA2000, or a 3.5G or 4G mobile communication network such as High Speed Downlink Packet Access (HSDPA) or High Speed Uplink Packet Access (HSUPA)).

A terminal may be referred to as a mobile station, a mobile terminal, a subscriber station, a portable subscriber station, a user equipment, an access terminal, etc. and may include some or all of functions thereof

Here, a desktop computer, laptop computer, tablet PC, wireless phone, mobile phone, smartphone, e-book reader, portable multimedia player (PMP), portable game console, navigation device, digital camera, digital multimedia broadcasting (DMB) player, digital audio recorder, digital audio player, digital picture recorder, digital picture player, digital video recorder, or digital video player may be used as the terminal

Throughout the specification, a base station may be referred to as an access point, radio access station, Node B, evolved Node B, base transceiver station, mobile multihop relay (MMR)-BS, etc., and may include some or all of functions thereof.

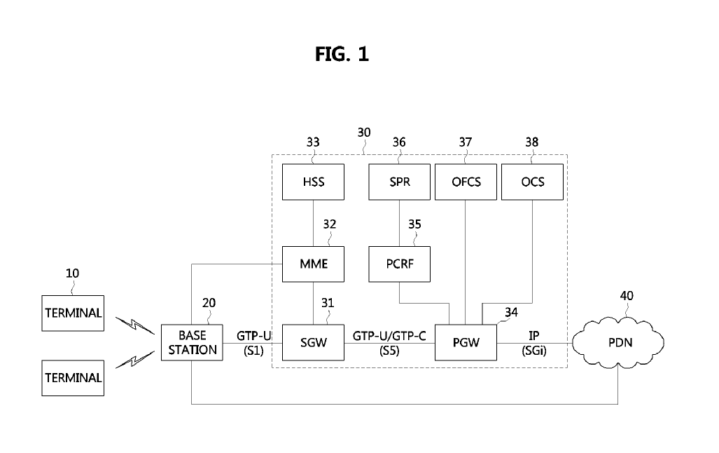

FIG. 1 is a block diagram showing a configuration of a communication network according to an embodiment of the present invention. Here, a base station 20 denotes a data offloading apparatus. For convenience of description, the data offloading apparatus is represented as the base station 20.

Referring to FIG. 1, a communication network may include at least one terminal 10, base station 20, mobile core network 30, packet data network (PDN) 40, etc. Here, the mobile core network 30 may denote a core network for a 2G mobile communication network, a core network for a 3G mobile communication network, a core network for a 4G mobile communication network, and a core network for a next generation mobile communication network (that is, B4G). The PDN 40 may denote an Internet network.

The base station 20 is connected wirelessly with at least one terminal 10 and connected by wire with the mobile core network 30 or the Internet network 40. The base station 20 may provide a packet, which is received from the terminal 10, to the Internet network 40 through the mobile core network 30 or provide the packet to the Internet network 40 through the route (for example, an Internet core network) of bypassing the mobile core network 30. That is, the terminal 10 may communicate with the Internet network 40 through the base station 20 and the mobile core network 30 or communicate with the Internet network 40 through the base station 20 and the Internet core network.

The mobile core network 30 may include a serving gateway (SGW) 31, a mobility management entity (MME) 32, a home subscriber server (HSS) 33, a PDN gateway (PGW) 34, a policy and charging rule function (PCRF) 35, a subscriber profile repository (SPR) 36, an offline charging system (OFCS) 37, and an online charging system (OCS) 38.

The SGW 31 serves as anchoring at the time of handover between the base stations 20. The MME 32 performs authentication on the terminal 10, manages mobility of the terminal 10, and manages an evolved packet system (EPS) bearer (that is, the generation, change, and removal of the bearer). The HSS 33 stores key information for authentication and a subscriber profile for each terminal 10 (or subscriber).

The PGW 34 allocates an Internet protocol (IP) address to the terminal 10, serves as anchoring at the time of change between SGWs 31, applies a separate quality of service (QoS) policy to each terminal 10 (or service), and manages accounting data for each terminal 10 (or service). Here, the accounting data includes upstream and downstream traffics, terminal connection time, etc., and the PGW 34 provides the accounting data to the OFCS 37 in a charging data record (CDR) form.

The PCRF 35 defines a charging rule and a QoS policy for each terminal 10. Here, the QoS policy is information used by the terminal 10 and the charging rule is information about whether the charging is performed online or offline. All the information is provided from the PCRF 35 to the PGW 34, and the PGW 34 performs the control (for example, QoS and charging) of the terminal 10 on the basis of the information received from the PCRF 35. The SPR 36 stores the charging rule and the QoS policy.

The OFCS 37 manages the CDR provided by the PGW 34. The OCS 38 manages the use state of the terminal 10 that uses a prepaid call plan. That is, the OCR 38 monitors the usage of the communication network of the terminal 10 that uses the prepaid call plan and provides the monitoring result to the PGW 34.

Here, the packet transmission between the base station 20 and the SGW 31 is performed through an S1 bearer, that is, a general packet radio service (GPRS) tunneling protocol (GTP)-U tunnel The packet transmission between the SGW 31 and the PGW 34 is performed through an S5 bearer, that is, the GTP-U tunnel The packet transmission between the PGW 34 and the Internet network 40 is performed through an SGi interface, that is, Internet protocol (IP). The packet transmission between the base station 20 and the Internet network 40 may be performed through a separate interface other than the GTP tunnel and IP.

FIG. 2 is a block diagram showing a configuration of a base station according to an embodiment of the present invention.

Referring to FIG. 2, the base station 20 may include an analysis unit 21 and a provision unit 22. Here, the base station 20 denotes a data offloading apparatus. For convenience of description, the data offloading apparatus is represented as the base station 20.

The analysis unit 21 may analyze the type of the packet on the basis of at least one of a header and a payload included in the packet received from the terminal 10.

Here, the packet received from the terminal 10 may be classified into a voice packet, a video packet, an Internet packet (for example, a packet for web surfing, etc.), a packet necessary to be transmitted according to the QoS policy, a packet not necessary to be transmitted according to the QoS policy, a packet to be charged for transmission, a packet not to be charged for transmission, etc.

The analysis unit 21 may analyze the type of the packet using the header, that is, 5-tuple (a source IP, destination IP, protocol identification (ID), source port, and destination port) included in the packet received from the terminal 10. That is, the analysis unit 21 may analyze the destination of the packet on the basis of the 5-tuple to analyze the type of the packet. For example, as the analysis result of the destination IP, the analysis unit 21 may analyze the packet as an Internet packet when the destination IP is an IP address of ‘www.google.com’.

The analysis unit 21 may analyze the type of the packet on the basis of the analysis result of the payload included in the packet received from the terminal 10. At this point, the analysis unit 21 may analyze the payload using a deep packet inspection (DPI) function. For example, the analysis unit 21 may analyze the packet as a voice packet when the payload includes voice-related data as the analysis result of the payload included in the packet.

The provision unit 22 may provide the packet to the Internet network 40 (see FIG. 1) through the mobile core network 30 or provide the packet to the Internet network 40 through the route (for example, an Internet core network) of bypassing the mobile core network 30 according to the type of the packet analyzed by the analysis unit. That is, the provision unit 22 may determine whether to offload the packet according to the type of the packet prior to the GTP tunneling of the packet.

If the packet is an Internet packet, the provision unit 22 may provide the Internet packet to the Internet network 40 using a route of bypassing the mobile core network 30. At this point, the provision unit 22 may provide the Internet packet to the Internet network 40 using an interface between the base station 20 and the Internet network 40. If the packet is not an Internet packet, the provision unit 22 may provide the packet to the Internet network 40 using the mobile core network 30. At this point, the provision unit 22 may provide the packet to the SGW 31 (see FIG. 1) using the GTP-U tunnel The packet provided to the SGW 31 may be provided to the PGW 34 (see FIG. 1) through the GTP-U tunnel, and the packet provided to the PGW 34 may be provided to the Internet network 40 through the Internet protocol (IP).

If the packet is a packet necessary to be transmitted according to the QoS policy, the provision unit 22 may provide the packet to the Internet network 40 using the mobile core network 30. At this point, the provision unit 22 may provide the packet to the SGW 31 using the GTP-U tunnel The packet provided to the SGW 31 may be provided to the PGW 34 through the GTP-U tunnel, and the packet provided to the PGW 34 may be provided to the Internet network 40 through the IP. If the packet is a packet not necessary to be transmitted according to the QoS policy, the provision unit 22 may provide the packet to the Internet network 40 through the route of bypassing the mobile core network 30. At this point, the provision unit 22 may provide the packet to the Internet network 40 using the interface between the base station 20 and the Internet network 40.

If the packet is a packet to be charged at the time of transmission, the provision unit 22 may provide the packet to the Internet network 40 using the mobile core network 30. At this point, the provision unit 22 may provide the packet to the SGW 31 using the GTP-U tunnel The packet provided to the SGW 31 may be provided to the PGW 34 through the GTP-U tunnel, and the packet provided to the PGW 34 may be provided to the Internet network 40 through the IP. If the packet is a packet not to be charged at the time of transmission, the provision unit 22 may provide the packet to the Internet network 40 through the route of bypassing the mobile core network 30. At this point, the provision unit 22 may provide the packet to the Internet network 40 using the interface between the base station 20 and the Internet network 40.

In the present invention, the analysis unit 21 and the provision unit 22 have been described as separate parts independent of each other. However, the analysis unit 21 and the provision unit 22 may be implemented as one physical device or module. Moreover, the analysis unit 21 and the provision unit 22 may be implemented as a plurality of physical devices or groups instead of one physical device or group.

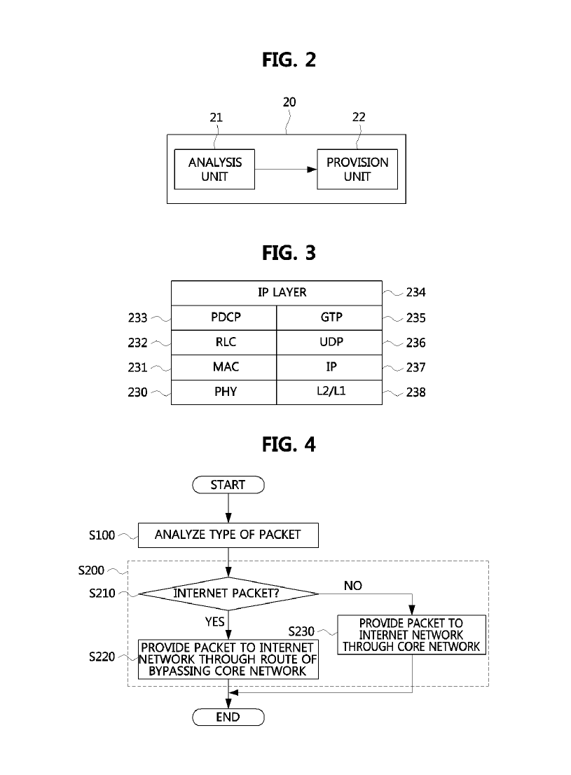

In addition, functions performed by the analysis unit 21 and the provision unit 22 may be substantially performed by a processor (for example, a central processing unit (CPU)). Also, the operations shown in FIGS. 4, 5, and 6, which will be described below, may be performed by the processor.

FIG. 3 is a block diagram showing a protocol configuration of a data offloading apparatus according to an embodiment of the present invention. Here, the base station denotes a data offloading apparatus. For convenience of description, the data offloading apparatus is represented as the base station.

Referring to FIG. 3, a protocol structure of the base station may include a first layer, a second layer, and an IP layer 234. Also, the protocol structure of the base station may further include a GTP 235, a user datagram protocol (UDP) 236, an IP 237, and an L2/L1 238, where the GTP 235, UDP 236, IP 237, and L2/L1 238 are responsible for the same function as each layer of the GPRS protocol.

The first layer may include a PHY layer 230, which performs general functions of the physical layer, such as coding/decoding, modulation/demodulation, multiple antenna mapping, etc.

The second layer may include a medium access control (MAC) layer 231, a radio link control (RLC) layer 232, and a packet data convergence protocol (PDCP) layer 233. Here, the MAC layer 231 performs functions such as hybrid automatic repeat request (HARQ) retransmission and scheduling, the RLC layer 232 performs functions such as segment/concatenation, retransmission management, and ordered data transmission, and the PDCP layer 233 performs functions such as IP header compression for reducing the number of bits transmitted over a wireless interface, ciphering/deciphering, and integrity protection.

The IP layer 234 may analyze the type of the packet on the basis of at least one of a header and a payload included in the packet provided from the second layer.

Here, the type of the packet may be classified into a voice packet, a video packet, an Internet packet, a packet necessary to be transmitted according to the QoS policy, a packet not necessary to be transmitted according to the QoS policy, a packet to be charged for transmission, a packet not to be charged for transmission, etc.

The IP layer 234 may analyze the type of the packet using the header, that is, 5-tuple (a source IP, destination IP, protocol identification (ID), source port, and destination port) included in the packet. That is, the IP layer 234 may analyze the destination of the packet on the basis of the 5-tuple to analyze the type of the packet. For example, as the analysis result of the destination IP, the analysis unit 21 may analyze the packet as the Internet packet when the destination IP is an IP address of ‘www.google.com’.

The IP layer 234 may analyze the type of the packet on the basis of the analysis result of the payload included in the packet. At this point, the IP layer 234 may analyze the payload using the DPI function. For example, the IP layer 234 may analyze the packet as a voice packet when the payload includes voice-related data as the analysis result of the payload included in the packet.

The IP layer 234 may allow the packet to be provided to the Internet network (or PDN) through the mobile core network or the route (that is, the Internet core network) of bypassing the mobile core network according to the analyzed type of the packet. That is, the IP layer 234 may determine whether to offload the packet according to the type of the packet prior to the GTP tunneling of the packet.

If the packet is an Internet packet, the IP layer 234 may allow the Internet packet to be provided to the Internet network through the route of bypassing the mobile core network. At this point, the IP layer 234 may allow the Internet packet to be provided to the Internet network using the interface between the base station and the Internet network. If the packet is not an Internet packet (for example, a voice packet, a video packet, etc.), the IP layer 234 may allow the packet to be provided to the Internet network using the mobile core network. At this point, the IP layer 234 may provide the packet to the SGW using the GTP-U tunnel The packet provided to the SGW may be provided to the PGW through the GTP-U tunnel, and the packet provided to the PGW may be provided to the Internet network through the IP. If the packet is a packet necessary to be transmitted according to the QoS policy, the IP layer 234 may allow the packet to be provided to the Internet network using the mobile core network. At this point, the IP layer 234 may provide the packet to the SGW using the GTP-U tunnel The packet provided to the SGW may be provided to the PGW through the GTP-U tunnel, and the packet provided to the PGW may be provided to the Internet network through the IP. If the packet is a packet not necessary to be transmitted according to the QoS policy, the IP layer 234 may allow the packet to be provided to the Internet network through the route of bypassing the mobile core network. At this point, the IP layer 234 may allow the packet to be provided to the Internet network using the interface between the base station and the Internet network.

If the packet is a packet to be charged for transmission, the IP layer 234 may allow the packet to be provided to the Internet network using the mobile core network. At this point, the IP layer 234 may provide the packet to the SGW using the GTP-U tunnel The packet provided to the SGW may be provided to the PGW through the GTP-U tunnel, and the packet provided to the PGW may be provided to the Internet network through the IP. If the packet is a packet not to be charged for transmission, the IP layer 234 may allow the packet to be provided to the Internet network through the route of bypassing the mobile core network. At this point, the IP layer 234 may allow the packet to be provided to the Internet network using the interface between the base station and the Internet network.

FIG. 4 is a flowchart illustrating a data offloading method according to an embodiment of the present invention. Here, the base station denotes a data offloading apparatus. For convenience of description, the data offloading apparatus is represented as the base station.

Referring to FIG. 4, the data offloading method may include analyzing the type of the packet (S100) and providing the packet to the Internet network through the mobile core network or the route (that is, the Internet core network) of bypassing the mobile core network (S200).

Here, the type of the packet may be classified into a voice packet, a video packet, an Internet packet, a packet necessary to be transmitted according to the QoS policy, a packet not necessary to be transmitted according to the QoS policy, a packet to be charged for transmission, a packet not to be charged for transmission, etc.

The base station may analyze the type of the packet using the header, that is, 5-tuple (a source IP, destination IP, protocol ID, source port, and destination port) included in the packet. That is, the base station may analyze the destination of the packet on the basis of the 5-tuple to analyze the type of the packet. For example, as the analysis result of the destination IP, the analysis unit 21 may analyze the packet as the Internet packet when the destination IP is an IP address of ‘www.google.com’.

The base station may analyze the type of the packet on the basis of the analysis result of the payload included in the packet (S100). At this point, the base station may analyze the payload using the DPI function. For example, the base station may analyze the packet as a voice packet when voice-related data is included in the payload as the analysis result of the payload included in the packet.

The base station may provide the packet to the Internet network through the mobile core network (S230) or the route of bypassing the mobile core network (S220) according to the analyzed type of the packet. That is, the base station may determine whether to offload the packet according to the type of the packet prior to the GTP tunneling of the packet.

If the packet is determined to be an Internet packet (S210), the base station may provide the Internet packet to the Internet network through the route of bypassing the mobile core network (S220). At this point, the base station may provide the internet packet to the Internet network using the interface between the base station and the Internet network.

If the packet is determined not to be an Internet packet (for example, a voice packet, a video packet, etc.) (S210), the base station may provide the packet to the Internet network through the mobile core network (S230). At this point, the base station may provide the packet to the SGW using the GTP-U tunnel The packet provided to the SGW may be provided to the PGW through the GTP-U tunnel, and the packet provided to the PGW may be provided to the Internet network through the IP.

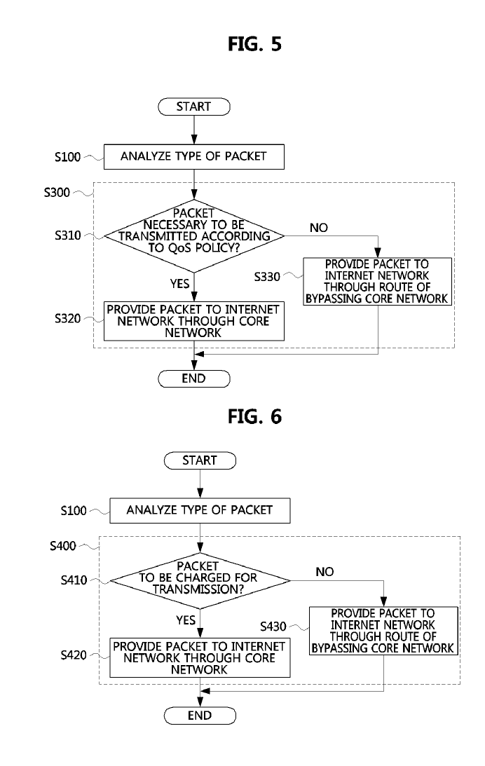

FIG. 5 is a flowchart illustrating a data offloading method according to another embodiment of the present invention. Here, the base station denotes a data offloading apparatus. For convenience of description, the data offloading apparatus is represented as the base station.

Referring to FIG. 5, the data offloading method may include analyzing the type of the packet (S100) and providing the packet to the Internet network through the mobile core network or the route (that is, the Internet core network) of bypassing the mobile core network

(S300). Here, operation S100 is the same as operation S100 of FIG. 4, which has been described above.

If the packet is determined to be a packet necessary to be transmitted according to the QoS policy (S310), the base station may provide the packet to the Internet network through the mobile core network (S320). At this point, the base station may provide the packet to the SGW using the GTP-U tunnel The packet provided to the SGW may be provided to the PGW through the GTP-U tunnel, and the packet provided to the PGW may be provided to the Internet network through the IP. If the packet is determined to be a packet not necessary to be transmitted according to the QoS policy (S310), the base station may provide the packet to the Internet network through the route of bypassing mobile core network (S330). At this point, the base station may provide the packet to the Internet network using the interface between the base station and the Internet network.

FIG. 6 is a flowchart illustrating a data offloading method according to still another embodiment of the present invention. Here, the base station denotes a data offloading apparatus. For convenience of description, the data offloading apparatus is represented as the base station.

Referring to FIG. 6, the data offloading method may include analyzing the type of the packet (S100) and providing the packet to the Internet network through the mobile core network or the route (that is, the Internet core network) of bypassing the mobile core network (S400). Here, operation S100 is the same as operation S100 of FIG. 4, which has been described above.

If the packet is determined to be a packet to be charged for transmission (S410), the base station may provide the packet to the Internet network through the mobile core network (S420). At this point, the base station may provide the packet to the SGW using the GTP-U tunnel The packet provided to the SGW may be provided to the PGW through the GTP-U tunnel, and the packet provided to the PGW may be provided to the Internet network through the IP.

If the packet is determined to be a packet not to be charged for transmission (S410), the base station may provide the packet to the Internet network through the route of bypassing the mobile core network (S430). At this point, the base station may provide the packet to the Internet network using the interface between the base station and the Internet network.

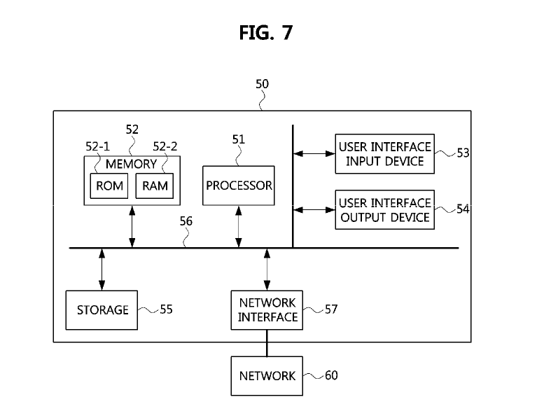

An embodiment of the present invention may be implemented in a computer system, e.g., as a computer readable medium. As shown in FIG. 7, a computer system 50 may include one or more of a processor 51, a memory 52, a user interface input device 53, a user interface output device 54, and a storage 55, each of which communicates through a bus 56.

The computer system 50 may also include a network interface 57 that is coupled to a network 60. The processor 51 may be a central processing unit (CPU) or a semiconductor device that executes processing instructions stored in the memory 52 and/or the storage 55. The memory 52 and the storage 55 may include various forms of volatile or non-volatile storage media. For example, the memory 52 may include a read-only memory (ROM) 52-1 and a random access memory (RAM) 52-2.

Accordingly, an embodiment of the invention may be implemented as a computer implemented method or as a non-transitory computer readable medium with computer executable instructions stored thereon. In an embodiment, when executed by the processor, the computer readable instructions may perform a method according to at least one aspect of the invention.

According to an embodiment of the present invention, it is possible to transfer data transferred from a terminal to an Internet network through the mobile core network or the route of bypassing the mobile core network (that is, the Internet core network) according to a type of data, thereby distributing data concentrated on the mobile core network and thus enhancing the entire performance of the communication network.

Also, since data concentrated on the mobile core network can be distributed, the capacity of the mobile core network does not have to be additionally expanded even though the amount of data transferred through the communication network increases, thereby being more cost effective than the related art.

While the example embodiments of the present invention and their advantages have been described in detail, it should be understood that various changes, substitutions, and alterations may be made herein without departing from the scope of the invention.

What is claimed is:

1. A data offloading apparatus comprising:
an analysis unit configured to analyze a type of a packet; and
a provision unit configured to provide the packet to an Internet network through a mobile core network or a route of bypassing the mobile core network on the basis of the type of the packet.

2. The data offloading apparatus of claim 1, wherein the analysis unit analyzes the type of the packet on the basis of at least one of a header and a payload included in the packet.

3. The data offloading apparatus of claim 1, wherein the provision unit provides the packet to the Internet network through the route of bypassing the mobile core network if the type of the packet is an Internet packet and through the mobile core network if the type of the packet is not an Internet packet.

4. The data offloading apparatus of claim 1, wherein the provision unit provides the packet to the Internet network through the mobile core network if the type of the packet is a packet necessary to be transmitted on the basis of a quality of service (QoS) policy and through the route of bypassing the mobile core network if the type of the packet is a packet not necessary to be transmitted on the basis of the QoS policy.

5. The data offloading apparatus of claim 1, wherein the provision unit provides the packet to the Internet network through the mobile core network if the type of the packet is a packet to be charged for transmission and through the route of bypassing the mobile core network if the type of the packet is a packet not to be charged for transmission.

6. The data offloading apparatus of claim 1, wherein the mobile core network is a 4G mobile communication core network.

7. A data offloading apparatus comprising:
a first layer serving as a physical layer;
a second layer serving as a data link layer; and
an Internet protocol (IP) layer analyzing a type of a packet provided by the second layer to provide the packet to an Internet network through a mobile core network or a route of bypassing the mobile core network on the basis of the analyzed type of the packet.

8. The data offloading apparatus of claim 7, wherein the IP layer analyzes the type of the packet on the basis of at least one of a header and a payload included in the packet.

9. The data offloading apparatus of claim 7, wherein the IP layer provides the packet to the Internet network through the route of bypassing the mobile core network if the type of the packet is an Internet packet and through the mobile core network if the type of the packet is not an Internet packet.

10. The data offloading apparatus of claim 7, wherein the IP layer provides the packet to the Internet network through the mobile core network if the type of the packet is a packet necessary to be transmitted on the basis of a quality of service (QoS) policy and through the route of bypassing the mobile core network if the type of the packet is a packet not necessary to be transmitted on the basis of the QoS policy.

11. The data offloading apparatus of claim 7, wherein the IP layer provides the packet to the Internet network through the mobile core network if the type of the packet is a packet to be charged for transmission and through the route of bypassing the mobile core network if the type of the packet is a packet not to be charged for transmission.

12. The data offloading apparatus of claim 7, wherein the mobile core network is a 4G mobile communication core network.

13. A data offloading method performed by a data offloading apparatus, the data offloading method comprising:
analyzing a type of a packet; and
providing the packet to an Internet network through a mobile core network or a route of bypassing the mobile core network on the basis of the type of the packet.

14. The data offloading method of claim 13, wherein the analyzing of the type of a packet is performed on the basis of at least one of a header and a payload included in the packet.

15. The data offloading method of claim 13, wherein the providing of the packet to an Internet network through a mobile core network or a route of bypassing the mobile core network on the basis of the type of the packet comprises providing the packet to the Internet network through the route of bypassing the mobile core network if the type of the packet is an Internet packet and through the mobile core network if the type of the packet is not an Internet packet.

16. The data offloading method of claim 13, wherein the providing of the packet to an Internet network through a mobile core network or a route of bypassing the mobile core network on the basis of the type of the packet comprises providing the packet to the Internet network through the mobile core network if the type of the packet is a packet necessary to be transmitted on the basis of a quality of service (QoS) policy and through the route of bypassing the mobile core network if the type of the packet is a packet not necessary to be transmitted on the basis of the QoS policy.

17. The data offloading method of claim 13, wherein the providing of the packet to an Internet network through a mobile core network or a route of bypassing the mobile core network on the basis of the type of the packet comprises providing the packet to the Internet network through the mobile core network if the type of the packet is a packet to be charged for transmission and through the route of bypassing the mobile core network if the type of the packet is a packet not to be charged for transmission.

18. The data offloading method of claim 13, wherein the mobile core network is a 4G mobile communication core network.
